(19) United States
(12) Patent Application Publication
(10) Pub. No.: US 2012/0325032 A1
(43) Pub. Date: Dec. 27, 2012

(54) AUXILIARY DEVICE FOR SLIDING MODULE

(75) Inventor: AN SZU HSU, New Taipei City (TW)

(73) Assignee: FIRST DOME CORPORATION, NEW TAIPEI CITY (TW)

(21) Appl. No.: 13/165,844

(22) Filed: Jun. 22, 2011

(51) Int. Cl. F16H 29/02

(52) U.S. Cl. 74/89.22

(57) ABSTRACT

An auxiliary device for a sliding module is disclosed. The auxiliary device includes a substrate having a guiding portion, a belt wheel rotatably disposed on the substrate, a wire disposed on the belt wheel, and a movable or sliding rack utilized for pivoting the wire. The sliding rack is movably attached to the guiding portion of the substrate and is capable of assembling with a sliding module. When the sliding rack driven by the sliding module is reciprocally moved, the sliding rack drives the wire to rotate the belt wheel, thus to minimize the unsmooth operation compared to conventional skills.

### BACKGROUND OF THE INVENTION

1. Field of the Invention

The present invention relates to an auxiliary device for a sliding module, and in particular relates to an auxiliary device utilized to assemble to a sliding or movable body, to assist in enhancing the motion stability and minimizing the shakiness of the movable body during the operational and assembling processes.

2. Description of the Related Art

For a conventional sliding cover system equipped in electronic devices such as mobile phones, notebook computers, personal digital assistants, digital cameras, e-books, etc., the sliding cover system can be reciprocally moved or slid by an external force, and a sliding cover portion of the sliding cover system is simply moved for the purpose of opening or closing.

As to the operation and movement of these kinds of sliding cover modules or sets, it is usually required cooperative components such as a movable rack, a linking plate, several elastic members, and wires or particular guide rails designed for linking and traction to assist with their opening or closing process. For the movable body of the electronic device with a heavy weight or a large movement distance, it is not expected that the motion stability of the sliding cover set or mechanism is influenced by the possible shakiness or swing when the movable body of the electronic device is operated by an user (e.g., applying a single side-pushing force).

Accordingly, some following topics of these kinds of sliding cover modules with respect to the actual operation movement shall be considered or overcome.

To possibly reduce the shakiness or swing of the sliding cover set, the sliding cover set shall be first equipped with an auxiliary device to assist in enhancing the stableness of sliding cover. To distinguish from the conventional skills, the structure of the auxiliary device shall be particularly provided with a reliable design of mechanism to assist in enhancing the motion stability and strength of the described components of the movable rack, the linking plate, the elastic members and the wires designed for linking and traction, so that the motion stability and smoothness of the sliding cover set can be relatively increased. Particularly, the auxiliary device shall be able to incorporate with a movable body of an electronic product with heavy weight and large movement distance.

Typically speaking, these reference data described above are related to the applications and design of structure of the sliding cover module or the related components thereof. However, these reference data are failed to physically teach or disclose that how to improve the conventional skills on decreasing the shakiness or swing of the sliding cover set and increasing the motion stability when the sliding cover module is operated.

Thus, it is essential to redesign a sliding cover and the related components, use patterns and applications thereof to be unique from that of the conventional skills.

### BRIEF SUMMARY OF THE INVENTION

Accordingly, the main purpose of the invention is to provide an auxiliary device for a sliding module. The auxiliary device includes a substrate having a guiding portion, a belt wheel rotatably disposed on the substrate, a wire disposed on the belt wheel, and a movable or sliding rack utilized for pivoting the wire. The sliding rack is movably attached to the guiding portion of the substrate and is capable of assembling with a sliding module. When the sliding rack driven by the sliding module is reciprocally moved, the sliding rack drives the wire to rotate the belt wheel, thus to minimize the unsmooth operation compared to conventional skills.

According to the auxiliary device of the invention for the sliding module, the wire comprises a line segment arranged in the guiding portion of the substrate and utilized to pivot to the sliding rack. Positioning wheels are respectively provided on two ends of the guiding portion of the substrate, and the wire outwardly exposed by the guiding portion of the substrate is allowed to wind on the positioning wheel and the belt wheel. In the adopted embodiment, the positioning wheels are selected of rotational or non-rotational type.

According to the auxiliary device of the invention for the sliding module, the guiding portion of the substrate is formed of a type of a slot chamber attached with a sliding rail. The sliding rack is allowed to be installed on the sliding rail disposed on the guiding portion of the substrate, so that the sliding rack can be slidably moved on the sliding rail or the guiding portion of the substrate.

According to the auxiliary device of the invention for the sliding module, the belt wheel can drive a transmission mechanism to perform another motion or function. For example, the belt wheel is utilized to drive a follower wheel which drives a rotating wheel and a toggle mechanism. Specifically, the toggle mechanism comprises a first arm pivoted to the rotating wheel, a second arm pivoted to the first arm, and an elastic member disposed between the first arm and the second arm. Therefore, the wire drives the belt wheel and the rotating wheel for rotation movement when a sliding cover module drives the sliding rack for reciprocal movement, so that the elastic member of the toggle mechanism stores energy therein, or release energy therefrom to generate an acting force to assist with the rotation of the rotating wheel. That is, the design of the transmission mechanism such as the rotating wheel, the toggle mechanism and the gate is capable of providing the acting force to assist with the movements of the sliding cover module, the belt wheel and the sliding rack.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an assembly of a substrate, a sliding rack, a belt wheel and a wire according to an embodiment of the present invention, wherein imaginary lines represent the arrangement or installation of guiding portions on the substrate;

FIG. 2 is an exploded schematic view of the structure of FIG. 1; and

FIG. 3 is a plan schematic view of FIG. 1, wherein imaginary lines represent the movement condition of the sliding rack and the condition of a transmission mechanism driven by the belt wheel.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

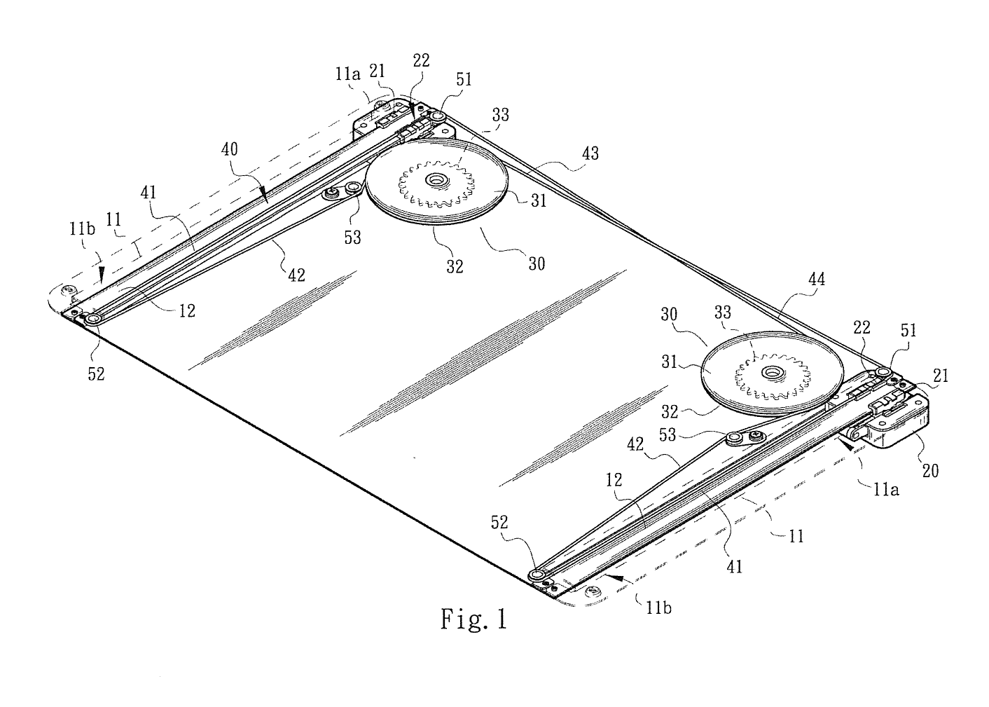

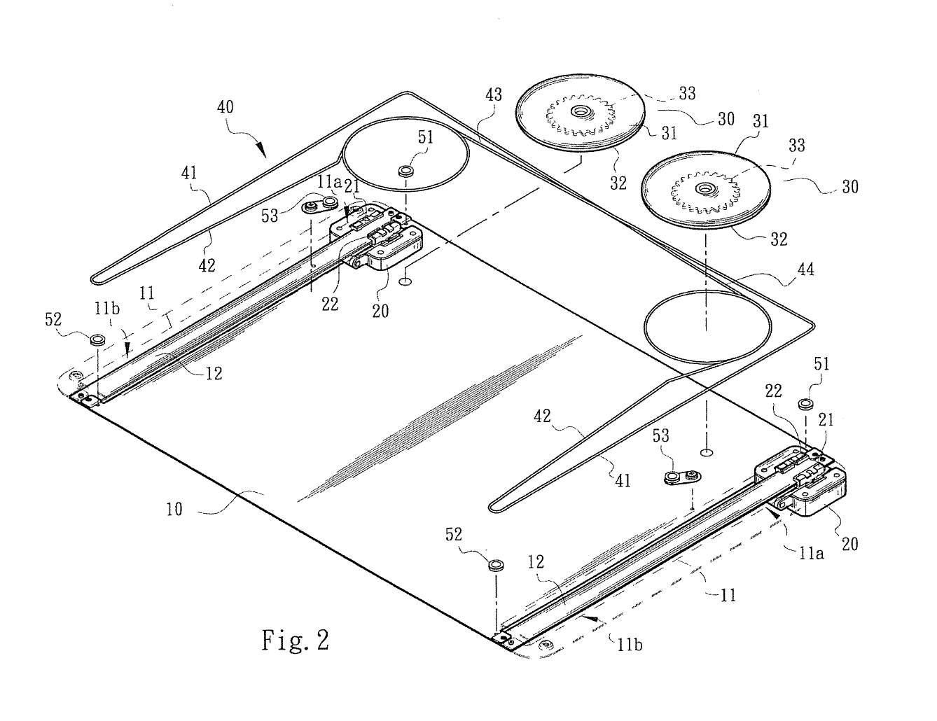

Referring to FIGS. 1 and 2, an auxiliary device of the invention for a sliding module comprises a substrate 10, two movable or sliding racks 20, two belt wheels 30 and a wire 40. The substrate 10, selected of a plate formed of a type of integral formation, is disposed on a fixed body of an electronic device (not shown in FIGs.). In the adopted embodiment, the substrate 10 comprises two guiding portions 11 represented by imaginary lines of FIGS. 1 and 2. The sliding racks 20, utilized for pivoting the wire 40 and disposed on the guiding portions 11 of the substrate 10, are movable on the guiding portions 11 of the substrate 10. The sliding racks 20 are capable of assembling to a movable body or a sliding unit (not shown in FIGs.) of an electronic device. The belt wheels 30 are rotatably disposed on the substrate 10, and the wire 40 is disposed on the belt wheels 30.

In FIGS. 1 and 2, the guiding portions 11 of the substrate 10, formed of types of slot chambers, are respectively attached with sliding rails 12, and the sliding racks 20 are respectively installed on the sliding rails 12, so that the sliding racks 20 are movable on the sliding rails 12, or it is summarily that the sliding racks 20 are movable on the guiding portions 11 of the substrate 10. In a preferred embodiment, the guiding portions 11 and the substrate 10 are formed of a type of integral formation or of a type of two individual independent components assembled to each other. Each guiding portion 11 is defined with a first end 11a and a second end 11b.

In FIG. 2, at least one hand portion 21 is provided on the bottom surface or the lower portion of each sliding rack 20, so that the sliding rack 20 is attached to the sliding rail 12 (or the guiding portion 11) via the hand portion 21 thereof. Each sliding rack 20 further comprises a limit portion 22 formed on the hand portion 21 and utilized to attach or fixedly assemble the wire 40 thereon. In the adopted embodiment, the limit portion 22 is formed of a type of a rabbet to embed or clamp the wire 40.

In a preferred embodiment, each belt wheel 30 has a periphery or circumferential end surface 31 formed of a type of a recess 32 for winding the wire 40 therein. The belt wheel 30 is further provided with a gear portion 33 utilized to drive a follower wheel or another transmission mechanism and the related content will be described hereinafter.

Referring to FIGS. 1 and 2, two line segments 41 of the wire 40 are arranged in the guiding portion 11 of the substrate 10 and utilized to pivot to the limit portions 22 of the sliding racks 20, respectively. Further, two sets of positioning wheels 51 and 52 are disposed on regions located in the vicinity of two ends, i.e., the first and second ends 11a and 11b, of the guiding portions 11 of the substrate 10, respectively. The rest of line segments 42, 43 and 44 of the wire 40, outwardly exposed by the guiding portion 11 of the substrate 10, are wound on the positioning wheels 51 and 52 and the belt wheel 30. In the adopted embodiment, the positioning wheels 51 and 52 are selected of rotational or non-rotational type. Two tension pulleys 53 is further provided on the substrate 10 to adjust the tightness of the wire 40 arranged on the positioning wheels 51 and 52 and the belt wheel 30.

In this embodiment, reference numbers 41, 42 and 43/44 stand for line segments of the wire 40 located in the guiding portions 11 of the substrate 10, between the positioning wheels 52 and the belt wheels 30, between the positioning wheels 51 and the belt wheels 30, respectively.

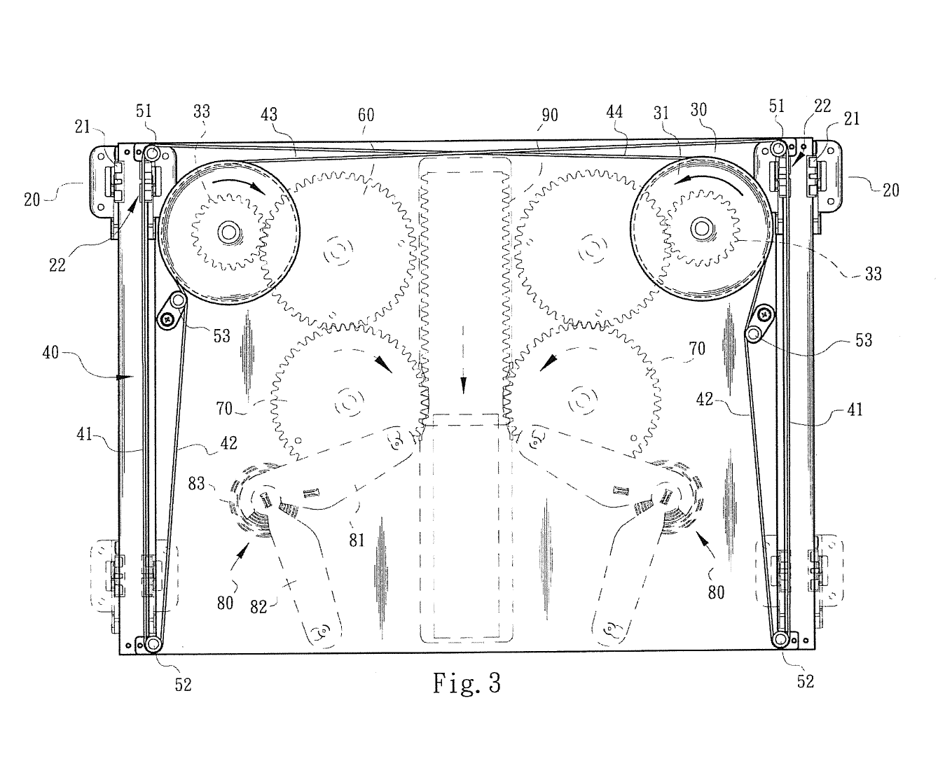

Referring to FIG. 3, the assembly and movement condition of the guiding portions 11, the sliding racks 20, the belt wheels 30 and the wire 40 are represented. In FIG. 3, it presumes that the sliding module represented by real line is in a closed position (i.e., the sliding rack 20 is located at the first end 11a of the guiding portion 11) to be defined as a first position, and the sliding module represented by imaginary line is in an open position (i.e., the sliding rack 20 is located at the first end 11b of the guiding portion 11) to be defined as a second position.

When each the sliding rack 20 driven by the sliding module is moved from the first end 11a (or the first position) to the second end 11b (or the second position) of the guiding portion 11, the sliding racks 20 drive the line segments 41 of the wire 40 to move toward the bottom of this figure, so that the line segments 42 of the wire 40 are moved toward the top of this figure to rotate the belt wheels 30. In FIG. 3, the rotation directions of the belt wheels 30 are indicated by arrows marked thereon, respectively. Further, the rotations of the belt wheels 30 drive the line segments 43 and 44 of the wire 40 to move toward the positioning wheels 51 to enter the guiding portions 11 of the substrate 10, respectively. It is therefore that, the movement of the wire 40 is a circulatory movement, and the sliding module is turned to the open status until the sliding racks 20 are moved to the second ends 11b of the guiding portions 11 of the substrate 10 (i.e., the position represented by imaginary line in FIG. 3).

It is understood that when each sliding rack 20 is reversed from the second end 11b (or the second position) to the first end 11a (or the first position) of the guiding portion 11, the sliding racks 20 drive the line segments 41 of the wire 40 to move toward the top of this figure, so that the line segments 42 of the wire 40 are moved toward the bottom of this figure to rotate the belt wheels 30, and the rotation of the belt wheels 30 drive the line segments 43 and 44 of the wire 40 to move from the positioning wheels 51 toward the belt wheels 30, respectively. The sliding module is turned to the closed status until the sliding racks 20 are moved to the first ends 11a of the guiding portions 11 (i.e., the position represented by imaginary line in FIG. 3), respectively.

In an applicable embodiment, the belt wheels 30 can be utilized to drive transmission mechanisms, represented by imaginary line in FIG. 3, to perform another motion or function. For example, each belt wheel 30 is utilized to drive a follower wheel 60 which drives a rotating wheel 70 and a toggle mechanism 80. When the rotating wheels 70 are rotated, a gate 90 is simultaneously driven by the rotating wheels 70 to generate linear displacement.

Specifically, each toggle mechanism 80 comprises a first arm 81 pivoted to the rotating wheel 70, a second arm 82 pivoted to the first arm 81, and an elastic member 83 disposed between the first arm 81 and the second arm 82. Therefore, the wire 40 drives the belt wheels 30, the follower wheels 60 and the rotating wheels 70 for rotation movement when a sliding cover module drives the sliding racks 20 for reciprocal movement, so that the elastic members 83 of the toggle mechanisms 80 store energy therein, or release energy therefrom to generate acting forces to assist with the rotation of the rotating wheels 70. That is, the design of the transmission mechanisms such as the rotating wheels 70, the toggle mechanisms 80 and the gate 90 are capable of providing the acting forces to assist with the movements of the sliding cover module, the belt wheels 30 and the sliding racks 20.

Typically speaking, with the co-operative movement of the sliding cover module, the auxiliary device of the invention for the sliding module provides the following particular considerations and advantages, compared to conventional skills.

By cooperating the belt wheels 30 and the wire 40 with the sliding racks 20 disposed on the guiding portions 11 (or the sliding rails 12), the unsmooth operation of conventional skills, or shakiness or swing caused by an user applying a single side-pushing force to operate the sliding cover module or mechanism can be minimized.

The invention provides a reliable arrangement design, totally different from conventional skills, for the structural pattern of the auxiliary device to assist in enhancing the motion stability and smoothness of the sliding module. In particular, the auxiliary device of the invention especially suitable for a movable body (or the sliding cover components) of an electronic device with heavy weight and large size.

To sum up, the invention provides an effective auxiliary device suitable for the sliding module and a particular space configuration much different from that in the conventional skills, and therefore the advantages and improvements of the invention certainly surpass the conventional skills.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An auxiliary device for a sliding module, comprising:
a substrate comprising a guiding portion defined with a first end and a second end;
a belt wheel rotatably disposed on the substrate, comprising a circumferential end surface;
a wire disposed on the belt wheel; and
a sliding rack utilized for pivoting the wire and attached to the guiding portion of the substrate, movable between the first end and the second end of the guiding portion of the substrate.

2. The auxiliary device for the sliding module as claimed in claim 1, wherein the guiding portion of the substrate is formed of a type of a slot chamber attached with a sliding rail, and the sliding rack is installed on the sliding rail disposed on the guiding portion of the substrate.

3. The auxiliary device for the sliding module as claimed in claim 1, wherein the guiding portion and the substrate are formed of a type of integral formation.

4. The auxiliary device for the sliding module as claimed in claim 1, wherein the guiding portion and the substrate are a type of two individual independent components assembled to each other.

5. The auxiliary device for the sliding module as claimed in claim 1, wherein the sliding rack is provided with at least one hand portion, so that a type of the sliding rack being attached to the guiding portion via the hand portion is formed.

6. The auxiliary device for the sliding module as claimed in claim 2, wherein the sliding rack is provided with at least one hand portion, so that a type of the sliding rack being attached to the sliding rail via the hand portion is formed.

7. The auxiliary device for the sliding module as claimed in claim 1, wherein the sliding rack comprises a limit portion.

8. The auxiliary device for the sliding module as claimed in claim 1, wherein the sliding rack is provided with at least one hand portion and a limit portion formed on the hand portion.

9. The auxiliary device for the sliding module as claimed in claim 8, wherein the limit portion is formed of a type of a rabbet.

10. The auxiliary device for the sliding module as claimed in claim 1, wherein the circumferential end surface of the belt wheel is formed of a type of a recess.

11. The auxiliary device for the sliding module as claimed in claim 1, wherein the belt wheel is provided with a gear portion.

12. The auxiliary device for the sliding module as claimed in claim 1, wherein the wire comprises a line segment arranged in the guiding portion of the substrate and utilized to pivot to the sliding rack.

13. The auxiliary device for the sliding module as claimed in claim 1, wherein a positioning wheel is provided on a region located in the vicinity of the first end and the second end of the guiding portion of the substrate, and the wire outwardly exposed by the guiding portion of the substrate is wound on the positioning wheel and the belt wheel.

14. The auxiliary device for the sliding module as claimed in claim 13, wherein the positioning wheel is selected of a rotational type.

15. The auxiliary device for the sliding module as claimed in claim 13, wherein the positioning wheel is selected of a non-rotational type.

16. The auxiliary device for the sliding module as claimed in claim 1, wherein a tension pulley is provided on the substrate.

17. The auxiliary device for the sliding module as claimed in claim 1, wherein the substrate is a plate formed of a type of integral formation.

18. The auxiliary device for the sliding module as claimed in claim 1, wherein a follower wheel, a toggle mechanism and a rotating wheel are provided, wherein the follower wheel and the toggle mechanism are driven by the belt wheel, and the rotating wheel and the toggle mechanism are driven by the follower wheel.

19. The auxiliary device for the sliding module as claimed in claim 18, wherein the toggle mechanism comprises a first arm pivoted to the rotating wheel, a second arm pivoted to the first arm, and an elastic member disposed between the first arm and the second arm.

20. The auxiliary device for the sliding module as claimed in claim 18, wherein a gate is driven by the rotating wheel to generate linear displacement.
